(19) United States
(12) Patent Application Publication
(10) Pub. No.: US 2009/0232227 A1
(43) Pub. Date: Sep. 17, 2009

(54) PULSE COMMUNICATION DEVICE, PULSE TRANSMITTING DEVICE, PULSE RECEIVING DEVICE, PULSE TRANSMITTING/RECEIVING DEVICE, ELECTRONIC APPARATUS, AND PULSE COMMUNICATION METHOD

(75) Inventor: Izumi IIDA, Shiojiri-shi (JP)

Correspondence Address: OLIFF & BERRIDGE, PLC, P.O. BOX 320850, ALEXANDRIA, VA, 22320-4850, US

(73) Assignee: Seiko Epson Corporation, Tokyo (JP)

(21) Appl. No.: 12/397,819

(22) Filed: Mar. 4, 2009

(30) Foreign Application Priority Data
Mar. 11, 2008 (JP) 2008-060677
Jan. 6, 2009 (JP) 2009-000591

(51) Int. Cl. H04B 14/04

(52) U.S. Cl. 375/242

(57) ABSTRACT

A pulse communication device includes a transmitting circuit including a base pulse generator adapted to generate a base pulse based on a base clock, and n (n is an integer equal to or greater than 1) data modulated pulse generators adapted to modulate a phase of the base pulse, which is generated based on the base clock, based on data to be transmitted, and output the result as a data modulated pulse, and a receiving circuit including n multipliers adapted to multiply a pair of pulses among the n data modulated pulses generated by the transmitting circuit and the base pulse to output multiplication signals, and n demodulators adapted to restore the data from the multiplication signals.

### BACKGROUND

1. Technical Field

The present invention relates to a pulse communication device, a pulse transmitting device, a pulse receiving device, a pulse transmitting/receiving device, an electronic apparatus, and a pulse communication method each using ultrawideband.

2. Related Art

Communications in ultrawideband (UWB) are communication methods for performing data communications using an extremely wide frequency band. As the communication method using signals in the wideband of UWB, there are cited a method using the conventional spectrum spreading, the orthogonal frequency division multiplexing (OFDM), and so on, and the impulse radio (IR) method using pulses with extremely short periods is also cited besides the above. In particular, the IR method in the UWB communication is called a UWB-IR method. Since in the UWB-IR method the modulation and demodulation can be achieved only by temporal operations without using conventional modulations, it is believed that simplification of circuits and lower power consumption can be expected.

In the UWB pulse communications, since the pulse width is as extremely narrow as a nanosecond range, synchronization capture and synchronization tracking become important. The synchronization mentioned here includes two types, namely pulse position synchronization for figuring out an approximate position of the pulse, and pulse phase synchronization related to the phase of the waveform of the pulse. For example, in the case of a pulse with the center frequency of 5 GHz and a pulse width of 1 ns, synchronization with an accuracy of about several hundreds of picoseconds is enough for the pulse position synchronization in the former, while the accuracy of several tens of picoseconds is required for the pulse phase synchronization in the latter. Although an envelope curve such as square detection requires only the pulse position synchronization, synchronized detection requires both of the pulse position synchronization and the pulse phase synchronization.

Although the synchronized detection is superior in performance to the square detection, there is a problem that the cost and the size increase in order for realizing the pulse phase synchronization. For example, in order for suppressing the phase shift within ten-odd picoseconds, it is necessary to use an oscillator with a small phase jitter, and therefore, it is difficult to use a simple ring oscillator. Further, since a large difference in frequency between the transmission side and the receiving side makes a variation in phase shift during the communication process too large to maintain the phase synchronization tracking, it is required to use a high-cost high-accuracy oscillator.

In order for solving this problem, JP-A-2005-12276 describes a method of using differential detection in which a base pulse and a data modulated pulse are transmitted with a time difference of T, and the receiving side corrects the delay to calculate the correlation by multiplication of the base pulse and the data modulated pulse. The differential detection is inferior in performance to the synchronized detection in which the receiving side reproduces a pulse waveform, but is superior in quality to the envelope detection.

However, in the method of the related art, there is a problem that it is difficult to realize the amount of delay necessary for the differential detection with an integrated circuit. For example, if it is attempted to realize the delay with a transmission channel, assuming that the pulse width is 1 ns, the length of the transmission channel required on the receiving side is equal to or greater than 10 cm.

### SUMMARY

Some aspects of the invention have an advantage of solving at least a part of the problem described above, and can be realized as the following embodiments or aspects.

A pulse communication device according to a first aspect of the invention includes a transmitting circuit including a base pulse generator adapted to generate a base pulse based on a base clock, and n (n is an integer equal to or greater than 1) data modulated pulse generators adapted to modulate a phase of the base pulse, which is generated based on the base clock, based on data to be transmitted, and output the result as a data modulated pulse, and a receiving circuit including n multipliers adapted to multiply a pair of pulses among the n data modulated pulses generated by the transmitting circuit and the base pulse to output multiplication signals, and n demodulators adapted to restore the data from the multiplication signals.

According to the present configuration, since the base pulses and the n data modulated pulses have the same configurations, the center frequency of the pulses and the pulse generation delay with respect to the timing clock can be regarded to be substantially the same between the both pulses, and therefore, it becomes possible to perform the stable demodulation independent of variations and the temperature on the receiving side.

The pulse communication device according to a second aspect of the invention has a feature, in the pulse communication device described above, that each of the data modulated pulse generators is a switch circuit adapted to modulate the phase of the base pulse generated by the base pulse generator based on the data to be transmitted and to output the result as the data modulated pulse.

According to the present configuration, since the n kinds of data modulated pulses can be generated only with the base pulse generator for generating the base pulse, the necessity of providing another pulse generator for generating the n kinds of data modulated pulses can be eliminated, and the circuit configuration can be reduced, and the power consumption can also be reduced. Further, it becomes also possible to further reduce the variation between the base pulses and the n data modulated pulses.

The pulse communication device according to a third aspect of the invention has a feature, in the pulse communication device described above, that one input of each of the n multipliers of the receiving circuit is the base pulse generated by the transmitting circuit.

According to the present configuration, since the base pulses and the n data modulated pulses have the same configurations, the center frequency of the pulses and the pulse generation delay with respect to the timing clock can be regarded to be substantially the same between the both pulses, and therefore, it becomes possible to perform the stable demodulation independent of variations and the temperature on the receiving side.

The pulse communication device according to a fourth aspect of the invention has a feature, in the pulse communication device described above, that one input of a predetermined multiplier included in the n multipliers of the receiving circuit is the base pulse generated by the transmitting circuit, and the multipliers included in the n multipliers and other than the predetermined multiplier each multiply a pair of pulses among the n data modulated pulses.

According to the present configuration, since the base pulses and the n data modulated pulses have the same configurations, the center frequency of the pulses and the pulse generation delay with respect to the timing clock can be regarded to be substantially the same between the both pulses, and therefore, it becomes possible to perform the stable demodulation independent of variations and the temperature on the receiving side. Further, since the number of multipliers to which the base pulse is distributed can be reduced, the distribution capacity can be suppressed to a low level, and the circuit scale and the power consumption can be reduced.

The pulse communication device according to a fourth aspect of the invention has a feature, in the pulse communication device described above, that the data modulated pulse generator executes multiple phase modulation, and the demodulator executes multiple phase demodulation.

According to the present configuration, it is possible to simultaneously transmit and receive the multiple phase data.

An electronic apparatus according to a sixth aspect of the invention includes the pulse communication device described above.

According to the present configuration, since the base pulses and the n data modulated pulses have the same configurations, the center frequency of the pulses and the pulse generation delay with respect to the timing clock can be regarded to be substantially the same between the both pulses, and therefore, it becomes possible to provide an electronic apparatus capable of performing the stable demodulation independent of variations and the temperature on the receiving side.

A pulse transmitting device according to a seventh aspect of the invention includes the transmitting circuit included in the pulse communication device described above, a first transmitting section adapted to transmit the base pulse, and a second transmitting section adapted to transmit the data modulated pulse.

A pulse receiving device according to an eighth aspect of the invention includes the receiving circuit included in the pulse communication device described above, a first receiving section adapted to receive the base pulse, and a second receiving section adapted to receive the data modulated pulse.

A pulse transmitting/receiving device according to a ninth aspect of the invention includes the transmitting circuit included in the pulse communication device described above, the receiving circuit included in the pulse communication device described above, a first transmitting/receiving section adapted to transmit and receive the base pulse, a second transmitting/receiving section adapted to transmit and receive the data modulated pulse, and a switch circuit adapted to connect either one of the transmitting circuit and the receiving circuit to the first and the second transmitting/receiving sections by switching.

An electronic apparatus according to a tenth aspect of the invention includes the pulse transmitting device described above.

An electronic apparatus according to an eleventh aspect of the invention includes the pulse receiving device described above.

An electronic apparatus according to a twelfth aspect of the invention includes the pulse transmitting/receiving device described above.

A pulse communication method according to a thirteenth aspect of the invention includes a transmission step having a base pulse generating step of generating a base pulse based on a base clock, and n (n is an integer equal to or greater than 1) data modulated pulse generating steps of modulating a phase of the base pulse, which is generated based on the base clock, based on data to be transmitted and outputting the result as a data modulated pulse, and a reception step having n multiplication steps of multiplying a pair of pulses among the n data modulated pulses generated in the transmission step and the base pulse and outputting a multiplication signal, and n restoring steps of restoring the data from the multiplication signals.

According to the present configuration, since the base pulses and the n data modulated pulses have the same configurations, the center frequency of the pulses and the pulse generation delay with respect to the timing clock can be regarded to be substantially the same between the both pulses, and therefore, it becomes possible to perform the stable demodulation independent of variations and the temperature on the receiving side.

### BRIEF DESCRIPTION OF THE DRAWINGS

The invention will now be described with reference to the accompanying drawings, wherein like numbers reference like elements.

FIG. 1 is a circuit diagram showing a configuration of a pulse communication device according to an embodiment.

FIG. 2 is a timing chart showing an operation of the pulse communication device according to the embodiment.

FIG. 3 is a circuit diagram showing a configuration of a transmission circuit according to a modified example 1.

FIG. 4 is a circuit diagram showing a configuration of a pulse communication device according to a modified example 2.

FIG. 5 is a circuit diagram showing a configuration of a pulse communication device according to a modified example 3.

FIG. 6 is a timing chart showing an operation of the pulse communication device according to the modified example 3.

FIG. 7 is a circuit diagram showing a configuration of a pulse communication device according to a modified example 4.

FIG. 8A is a table chart showing setting of the pulse communication device according to the modified example 4, and FIG. 8B is a timing chart showing an operation thereof.

FIG. 9 is an appearance diagram showing a configuration of an electronic apparatus equipped with a pulse communication device according to a modified example 5.

FIG. 10A is a schematic diagram showing a configuration of a transmitter as an electronic apparatus equipped with a pulse transmission device according to a modified example 6, and FIG. 10B is a schematic diagram showing a configuration of a receiver as an electronic apparatus equipped with a pulse receiving device according to the modified example 6.

FIG. 11 is a schematic diagram showing a configuration of a pulse transmitting/receiving device according to a modified example 7.

### DESCRIPTION OF EXEMPLARY EMBODIMENTS

Hereinafter, the embodiment of a pulse communication device will be explained with reference to the accompanying drawings.

### Embodiment

### Configuration of Pulse Communication Device

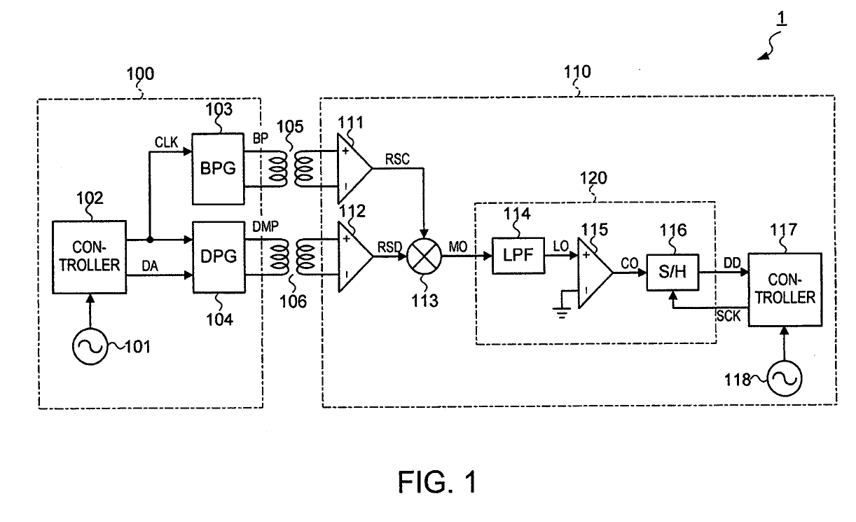

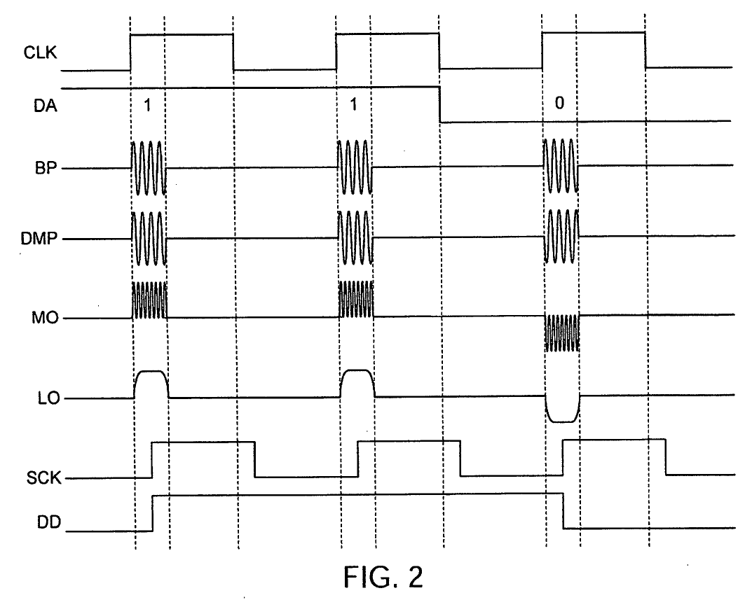

Firstly, a configuration of the pulse communication device according to the embodiment will be explained with reference to FIGS. 1 and 2. FIG. 1 is a circuit diagram showing the configuration of the pulse communication device according to the embodiment. FIG. 2 is a timing chart showing an operation of the pulse communication device according to the embodiment.

As shown in FIG. 1, the pulse communication device 1 is composed of a transmission circuit 100 and a receiving circuit 110.

The transmission circuit 100 is composed of an oscillator 101, a controller 102, a base pulse generator (BPG) 103, and n (=1) data modulated pulse generator (DPG) 104.

The controller 102 generates a base clock CLK based on a clock signal generated by the oscillator 101, and outputs the base clock CLK to the base pulse generator 103 and the data modulated pulse generator 104. Further, the controller 102 outputs data DA, which is to be transmitted, to the data modulated pulse generator 104.

The base pulse generator 103 generates the base pulses BP in a form of differential signals based on the base clock CLK, and transmits the base pulses BP to the receiving circuit 110 with electromagnetic coupling by a coil 105. As shown in FIG. 2, the base pulse generator 103 is provided with a pulse generator (not shown) for generating a predetermined number of cycles (four cycles in FIG. 2) of the base pulses BP at a rising edge of the base clock CLK.

The data modulated pulse generator 104 generates the data modulated pulses DMP in a form of differential signals based on the base clock CLK and the data DA, and transmits the data modulated pulse DMP to the receiving circuit 110 with electromagnetic coupling by a coil 106. The data modulated pulse generator 104 is provided with a pulse generator equivalent to the base pulse generator 103, and as shown in FIG. 2, generates the data modulated pulse DMP in-phase with the base pulse BP when the data DA is “1,” and generates the data modulated pulse DMP with the phase reversed to that of the base pulse BP when the data DA is “0.”

The receiving circuit 110 is composed of two differential amplifiers 111, 112, n (=1) multiplier 113, one demodulator 120, a controller 117, and an oscillator 118. The demodulator 120 is composed of a low pass filter (LPF) 114, a comparator 115, and a sample hold (S/H) circuit 116.

The differential amplifier 111 receives the base pulse BP generated by the base pulse generator 103 with electromagnetic coupling by the coil 105, and outputs an amplified base pulse signal RSC. The differential amplifier 112 receives the data modulated pulse DMP generated by the data modulated pulse generator 104 with electromagnetic coupling by the coil 106, and outputs an amplified data modulated pulse signal RSD. The multiplier 113 multiplies the base pulse signal RSC by the data modulated pulse signal RSD, and outputs a multiplication signal MO shown in FIG. 2.

The low pass filter 114 outputs a filtered signal LO shown in FIG. 2 obtained by filtering the high frequency component of the multiplication signal MO. The comparator 115 outputs a comparative signal CO obtained by comparing the filtered signal LO and the ground potential. The controller 117 outputs a sampling clock SCK, which is generated based on a clock generated by the oscillator 118, to a sample and hold circuit 116, and as shown in FIG. 2, the sample and hold circuit 116 holds the comparative signal CO at a time point at which the sampling clock SCK rises, and outputs demodulated data DD to the controller 117.

As shown in FIG. 2, since the base pulses BP and the data modulated pulses DMP are generated based on the base clock CLK, the center frequency of the pulses and a pulse generation delay can be regarded to be substantially the same as each other.

According to the present embodiment described above, the following advantages can be obtained.

Since in the present embodiment the base pulses BP and the data modulated pulses DMP have the same configurations, the center frequency of the pulses and the pulse generation delay with respect to the timing clock can be regarded to be substantially the same between the both pulses, and therefore, it becomes possible to perform the stable demodulation independent of variations and the temperature on the receiving side.

Although in the present embodiment the base pulses are assumed to be free from modulation, it is also possible to execute phase modulation thereon with a scramble code in order for reducing the peak value of the spectrum to suppress interference to other systems. On this occasion, by previously multiplying the transmission data and the base pulse by the same scramble code, it becomes possible to correctly demodulate the data without providing a modification to the circuit on the receiving side.

Although the embodiment of the pulse communication device is explained hereinabove, the invention is not at all limited to such an embodiment, but can be put into practice in various forms within the scope of the invention. Modified examples thereof will hereinafter be explained.

### MODIFIED EXAMPLE 1

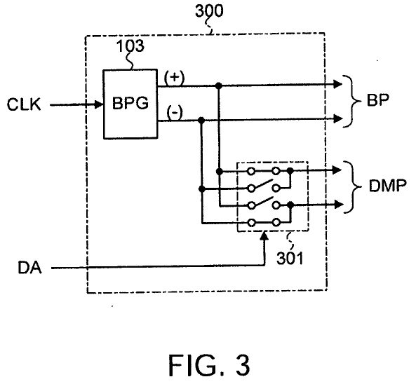

A modified example 1 of the pulse communication device will be explained. Although in the embodiment described above it is explained that the base pulse generator 103 and the data modulated pulse generator 104 of the transmitting circuit 100 are provided with the pulse generators equivalent to each other, it is also possible to configure the data modulated pulse generator 104 with a switch circuit 301 as a transmitting circuit 300 shown in FIG. 3. The switch circuit 301 is switched so as to generate the data modulated pulse DMP in-phase with the base pulse BP when the data DA is “1,” and is switched so as to generate the modulated pulse DMP with the phase reversed to that of the base pulse BP when the data DA is “0.”

According to this configuration, since only the base pulse generator 103 for generating the base pulses BP is provided with the pulse generator, and the data modulated pulses DMP can be generated by the switch circuit 301, the necessity of providing another pulse generator for generating the data modulated pulses DMP no longer exists, and it becomes possible to reduce constituents of the circuit and to reduce the power consumption. Further, it becomes also possible to further reduce the variation between the base pulses BP and the data modulated pulses DMP.

Further, since the present modified example can cope with even the case in which the phase modulation is executed on the base pulses with the scramble code in order for reducing the peak value of the spectrum of the base pulse without modifying the configurations of the generator and the receiving circuit of the data modulated pulses, increase in the circuit scale or the power consumption can be eliminated.

### MODIFIED EXAMPLE 2

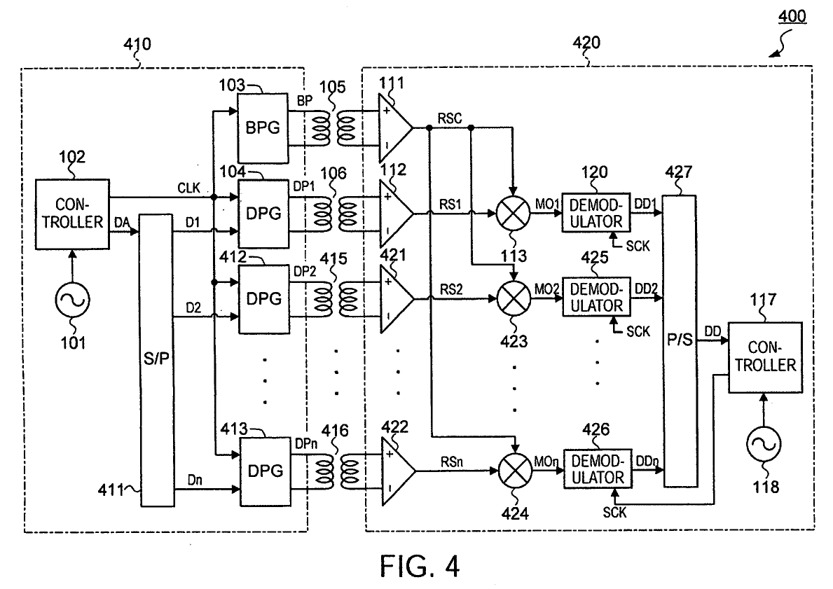

A modified example 2 of the pulse communication device will be explained. Although in the embodiment described above the case of generating the n (=1) kind of data modulated pulses DMP is explained, it is also possible to adopt a configuration of generating a plurality of kinds of data modulated pulses DP1 through DPn as shown in FIG. 4.

FIG. 4 is a circuit diagram showing the configuration of the pulse communication device according to a modified example 2. As shown in FIG. 4, the pulse communication device 400 is composed of a transmitting circuit 410 for transmitting the n data modulated pulses DP1 through DPn, and a receiving circuit 420 for receiving the n data modulated pulses DP1 through DPn.

The transmitting circuit 410 is provided with a serial/parallel converter 411 for converting the n bit data DA into n parallel data D1 through Dn, and n−1 data modulated pulse generators 412 through 413 in addition to the constituents of the transmitting circuit 100 of the embodiment such as oscillator 101, the controller 102, the base pulse generator 103, and the data modulated pulse generator 104.

The data modulated pulse generator 104 generates the data modulated pulses DP1 from the base clock CLK and the first bit data D1, and transmits them via the coil 106. The data modulated pulse generator 412 generates the data modulated pulses DP2 from the base clock CLK and the second bit data D2, and transmits them via a coil 415. Similarly, the data modulated pulse generator 413 generates the data modulated pulses DPn from the base clock CLK and the nth bit data Dn, and transmits them via a coil 416.

The receiving circuit 420 is provided with n−1 differential amplifiers 421 through 422, n−1 multipliers 423 through 424, n−1 demodulators 425 through 426, and a parallel/serial converter 427 in addition to the constituents of the receiving circuit 110 of the embodiment such as the two differential amplifiers 111, 112, the multiplier 113, the demodulator 120, the controller 117, and the oscillator 118.

The differential amplifier 112 receives the data modulated pulses DP1 via the coil 106, and outputs the data modulated pulse signal RS1. The multiplier 113 multiplies the base pulse signal RSC by the data modulated pulse signal RS1, and outputs a multiplication signal MO1. The demodulator 120 outputs the demodulated signal DD1 obtained by demodulating the multiplication signal MO1.

The differential amplifier 421 receives the data modulated pulses DP2 via the coil 415, and outputs the data modulated pulse signal RS2. The multiplier 423 multiplies the base pulse signal RSC by the data modulated pulse signal RS2, and outputs a multiplication signal MO2. The demodulator 425 outputs a demodulated signal DD2 obtained by demodulating the multiplication signal MO2.

Similarly, the differential amplifier 422 receives the data modulated pulses DPn via the coil 416, and outputs a data modulated pulse signal RSn. The multiplier 424 multiplies the base pulse signal RSC by the data modulated pulse signal RSn, and outputs a multiplication signal MOn. The demodulator 426 outputs a demodulated signal DDn obtained by demodulating the multiplication signal MOn.

The parallel/serial converter 427 converts the demodulated signals DD1 through DDn into serial demodulated data DD, and outputs the data DD to the controller 117.

According to the present configuration, since the n bit serial data is converted into the parallel data thereby performing the transmission and reception in a parallel manner, the data can be transmitted and received at a higher rate.

### MODIFIED EXAMPLE 3

A modified example 3 of the pulse communication device will be explained. Although in the modified example 2, the case in which one input of each of the n multipliers 113 and 423 through 424 is provided with the base pulse signal RSC is explained, it is required to dispose a buffer circuit or the like in order for improving the drive capacity of the base pulse signal RSC.

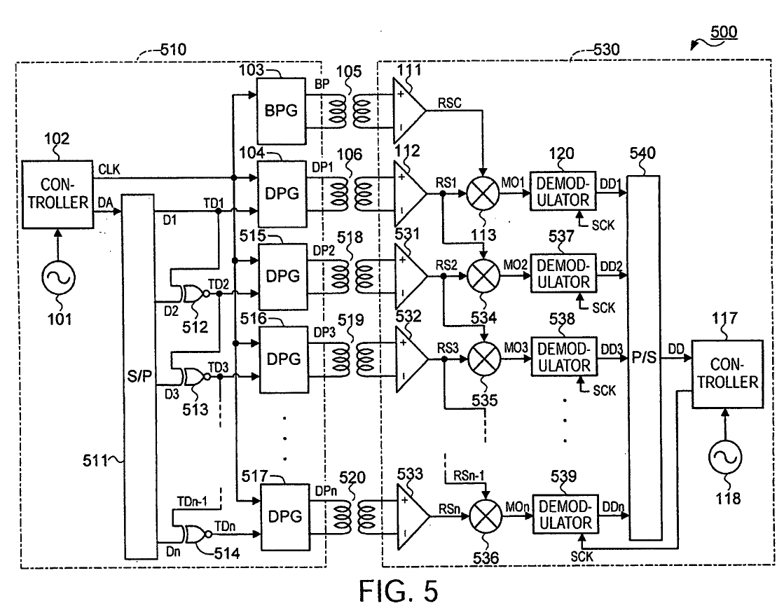

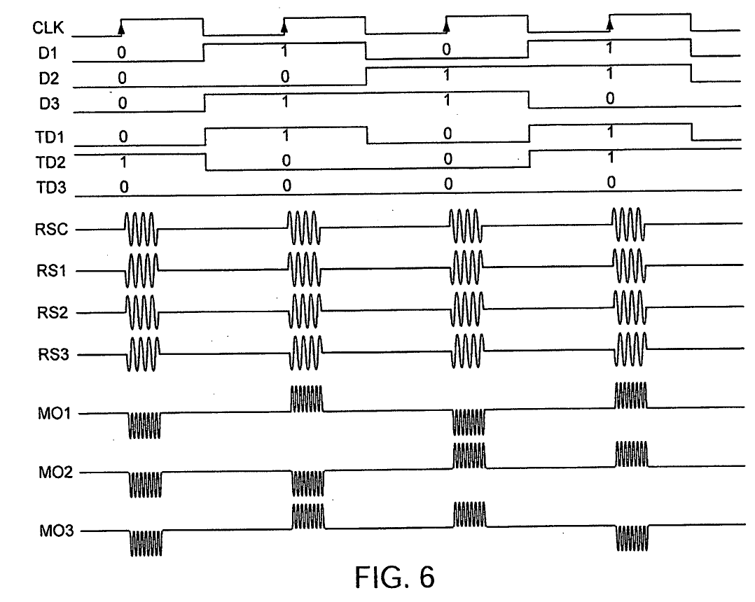

FIG. 5 is a circuit diagram showing the configuration of the pulse communication device according to a modified example 3. FIG. 6 is a timing chart showing an operation of the pulse communication device according to the modified example 3. As shown in FIG. 5, the pulse communication device 500 is composed of a transmitting circuit 510 for transmitting the n data modulated pulses DP1 through DPn, and a receiving circuit 530 for receiving the n data modulated pulses DP1 through DPn.

The transmitting circuit 510 is provided with a serial/parallel converter 511 for converting the n bit data DA into the n parallel data D1 through Dn, n EX-NOR circuits 512 through 514, and n−1 data modulated pulse generators 515 through 517 in addition to the constituents of the transmitting circuit 100 of the embodiment such as oscillator 101, the controller 102, the base pulse generator 103, and the data modulated pulse generator 104.

The data modulated pulse generator 104 generates the data modulated pulses DP1 from the base clock CLK and the first bit data D1 (TD1), and transmits them via the coil 106.

The EX-NOR circuit 512 outputs a signal TD2 obtained by executing EX-NOR on the first bit data D1 (TD1) and the second bit data D2. The data modulated pulse generator 515 generates the data modulated pulses DP2 from the base clock CLK and the signal TD2, and transmits them via a coil 518.

The EX-NOR circuit 513 outputs a signal TD3 obtained by executing EX-NOR on the signal TD2 and the third bit data D3. The data modulated pulse generator 516 generates the data modulated pulses DP3 from the base clock CLK and the signal TD3, and transmits them via a coil 519.

Similarly, the EX-NOR circuit 514 outputs a signal TDn obtained by executing EX-NOR on a signal TDn−1 and the nth bit data Dn. The data modulated pulse generator 517 generates the data modulated pulses DPn from the base clock CLK and the signal TDn, and transmits them via a coil 520.

The receiving circuit 530 is provided with n−1 differential amplifiers 531 through 533, n−1 multipliers 534 through 536, n−1 demodulators 537 through 539, and a parallel/serial converter 540 in addition to the constituents of the receiving circuit 110 of the embodiment such as the two differential amplifiers 111, 112, the multiplier 113, the demodulator 120, the controller 117, and the oscillator 118.

The differential amplifier 112 receives the data modulated pulses DP1 via the coil 106, and outputs the data modulated pulse signal RS1. The multiplier 113 multiplies the base pulse signal RSC by the data modulated pulse signal RS1, and outputs the multiplication signal MO1. The demodulator 120 outputs the demodulated signal DD1 obtained by demodulating the multiplication signal MO1.

The differential amplifier 531 receives the data modulated pulses DP2 via the coil 518, and outputs the data modulated pulse signal RS2. The multiplier 534 multiplies the data modulated pulse signal RS1 by the data modulated pulse signal RS2, and outputs the multiplication signal MO2. The demodulator 537 outputs the demodulated signal DD2 obtained by demodulating the multiplication signal MO2.

The differential amplifier 532 receives the data modulated pulses DP3 via the coil 519, and outputs the data modulated pulse signal RS3. The multiplier 535 multiplies the data modulated pulse signal RS2 by the data modulated pulse signal RS3, and outputs the multiplication signal MO3. The demodulator 538 outputs the demodulated signal DD3 obtained by demodulating the multiplication signal MO3.

Similarly, the differential amplifier 533 receives the data modulated pulses DPn via the coil 520, and outputs a data modulated pulse signal RSn. The multiplier 536 multiplies the data modulated pulse signal RSn−1 by the data modulated pulse signal RSn, and outputs the multiplication signal MOn. The demodulator 539 outputs the demodulated signal DDn obtained by demodulating the multiplication signal MOn.

The parallel/serial converter 540 converts the demodulated signals DD1 through DDn into the serial demodulated data DD, and outputs the data DD to the controller 117.

According to the present configuration, since the necessity of disposing the buffer circuit or the like in order for improving the drive capacity of the base pulse signal RSC in the case of the modified example 2 is eliminated, the increase in power consumption can be suppressed, and further, since the n bit serial data can be transmitted and received in parallel by converting it into the parallel data, it becomes possible to transmit and receive the data at a higher rate.

### MODIFIED EXAMPLE 4

A modified example 4 of the pulse communication device will be explained. Although in the embodiment the case of transmitting and receiving the binary phase data is explained, it is also possible to transmit and receive multiple phase data. Although in the present modified example quadri-phase transmission/reception will be explained, the invention is not limited thereto.

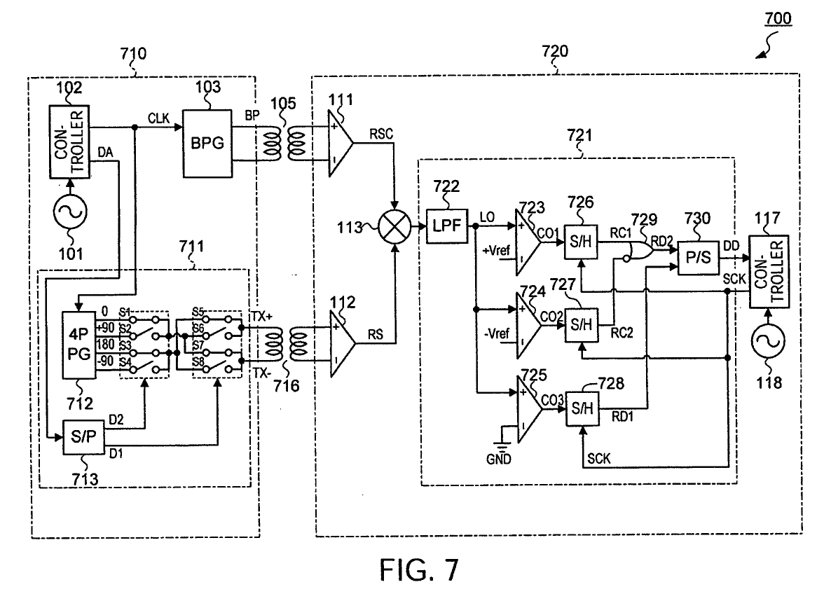

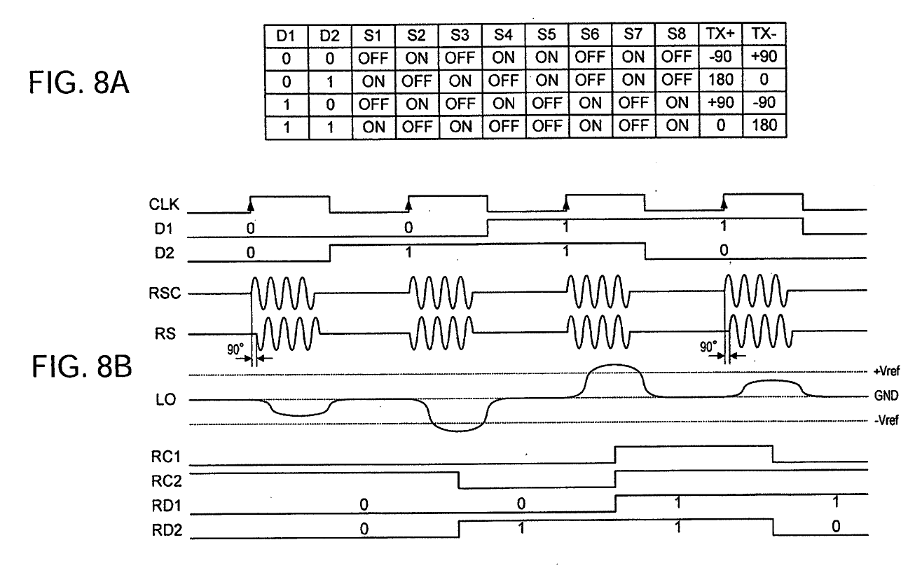

FIG. 7 is a circuit diagram showing the configuration of the pulse communication device according to the modified example 4. FIG. 8A is a table chart showing setting of the pulse communication device according to the modified example 4. FIG. 8B is a timing chart showing an operation of the pulse communication device according to the modified example 4. As shown in FIG. 7, the pulse communication device 700 is composed of a transmitting circuit 710 for transmitting quadri-phase data modulated pulses TX, and a receiving circuit 720 for receiving the quadri-phase data modulated pulses TX.

The transmitting circuit 710 is provided with the oscillator 101, the controller 102, and the base pulse generator 103 forming the transmitting circuit 100 of the embodiment, and a quadri-phase data modulated pulse generator 711 instead of the data modulated pulse generator 104.

The quadri-phase data modulated pulse generator 711 is composed of a quadri-phase pulse generator 712, a serial/parallel converter 713, and eight switch elements S1 through S8. The serial/parallel converter 713 converts the two bits data DA to be transmitted into two parallel data D1, D2. As shown in the table chart of FIG. 8A, the eight switch elements S1 through S8 are switched based on the parallel data D1, D2, and output the data modulated pulse TX+/TX−.

The receiving circuit 720 is provided with the two differential amplifiers 111, 112, the multiplier 113, the controller 117, and the oscillator 118 forming the receiving circuit 110 of the embodiment, and a quadri-phase demodulator 721 instead of the demodulator 120.

The quadri-phase demodulator 721 is provided with a low pass filter 722, three comparators 723, 724, 725, three sample and hold circuits 726, 727, 728, a NOR circuit 729, and a serial/parallel converter 730.

According to the present configuration, it is possible to simultaneously transmit and receive the multiple phase data.

### MODIFIED EXAMPLE 5

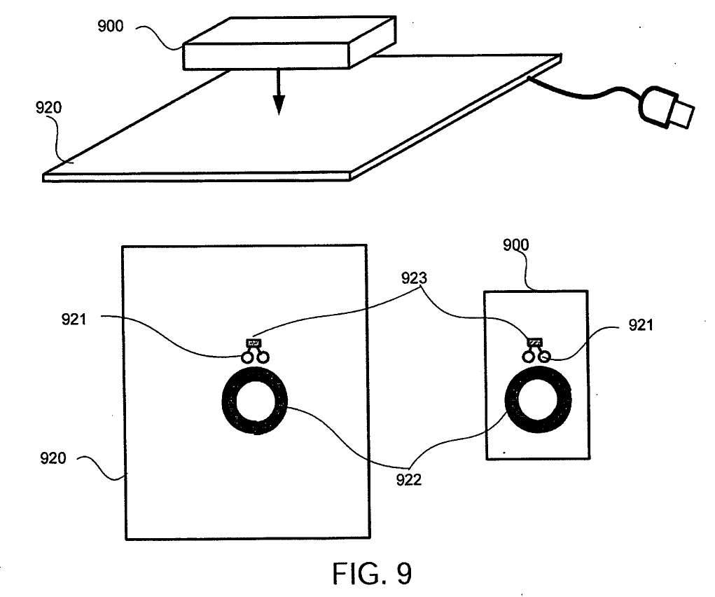

A modified example 5 of the pulse communication device will be explained. FIG. 9 is an appearance diagram of a cellular phone 900 and a battery charger 920 as an example of an electronic apparatus equipped with the pulse communication device. The cellular phone 900 and the battery charger 920 are each provided with a transmitting/receiving antenna 921, a pulse communication device 923, and a power transmission coil 922. According to the present configuration, by disposing the cellular phone 900 in alignment with the battery charger 920, the high-speed data communication at the same time as the power transmission becomes possible.

### MODIFIED EXAMPLE 6

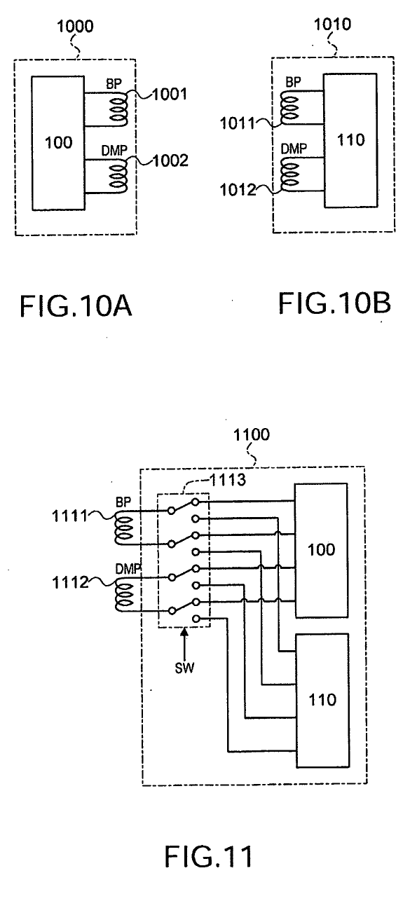

A modified example 6 of the pulse communication device will be explained. FIG. 10A is a schematic diagram showing a configuration of a transmitter as an electronic apparatus equipped with a pulse transmitting device, and FIG. 10B is a schematic diagram showing a configuration of a receiver as an electronic apparatus equipped with a pulse receiving device. A transmitter 1000 is configured including the transmitting circuit 100 (or 300), a coil 1001 as a first transmitting section for transmitting the base pulses BP, and a coil 1002 as a second transmitting section for transmitting the data modulated pulses DMP. A receiver 1010 is configured including the receiving circuit 110, a coil 1011 as a first receiving section for receiving the base pulses BP, and a coil 1012 as a second receiving section for receiving the data modulated pulses DMP. The transmitter 1000 and the receiver 1010 can transmit and receive the base pulses BP and the data modulated pulses DMP by the electromagnetic coupling between the coils 1001 and 1011, and between the coils 1002 and 1012 when the transmitter 1000 and the receiver 1010 are disposed at a short distance.

### MODIFIED EXAMPLE 7

A modified example 7 of the pulse communication device will be explained. FIG. 11 is a schematic diagram showing a configuration of a pulse transmitting/receiving device. The pulse transmitting/receiving device 1100 is configured including the transmitting circuit 100 (or 300), the receiving circuit 110, a coil 1111 as a first transmitting/receiving section, a coil 1112 as a second transmitting/receiving section, and a switching circuit 1113. The switching circuit 1113 can perform switching so as to bring the transmitting circuit 100 and the coils 1111, 1112 into a coupled condition or bring the receiving circuit 110 and the coils 1111, 1112 into a coupled condition based on a control signal SW. For example, in FIG. 9, it is possible to configure the two pulse communication devices 923 with the pulse transmitting/receiving devices 1100, and to set the control signals SW so as to bring the transmitting circuit 100 and the coils 1111 and 1112 into coupled condition in one of the pulse transmitting/receiving devices 1100 and to bring the receiving circuit 110 and the coils 1111 and 1112 into coupled condition in the other of the pulse transmitting/receiving devices 1100.

The entire disclosure of Japanese Patent Applications Nos: 2008-060677 filed Mar. 11, 2008 and 2009-000591 filed Jan. 6, 2009 are expressly incorporated by reference herein.

What is claimed is:

1. A pulse communication device comprising:
a transmitting circuit including
a base pulse generator adapted to generate a base pulse based on a base clock, and
n (n is an integer equal to or greater than 1) data modulated pulse generators adapted to modulate a phase of the base pulse, which is generated based on the base clock, based on data to be transmitted, and output the result as a data modulated pulse; and
a receiving circuit including
n multipliers adapted to multiply a pair of pulses among the n data modulated pulses generated by the transmitting circuit and the base pulse to output multiplication signals, and
n demodulators adapted to restore the data from the multiplication signals.

2. The pulse communication device according to claim 1, wherein
each of the data modulated pulse generators is a switch circuit adapted to modulate the phase of the base pulse generated by the base pulse generator based on the data to be transmitted and to output the result as the data modulated pulse.

3. The pulse communication device according to claim 1, wherein
one input of each of the n multipliers of the receiving circuit is the base pulse generated by the transmitting circuit.

4. The pulse communication device according to claim 1, wherein
one input of a predetermined multiplier included in the n multipliers of the receiving circuit is the base pulse generated by the transmitting circuit, and
the multipliers included in the n multipliers and other than the predetermined multiplier each multiply a pair of pulses among the n data modulated pulses.

5. The pulse communication device according to claim 1, wherein
the data modulated pulse generator executes multiple phase modulation, and
the demodulator executes multiple phase demodulation.

6. A pulse transmitting/receiving device comprising:
the transmitting circuit included in the pulse communication device according to claim 1;
the receiving circuit included in the pulse communication device according to claim 1;
a first transmitting/receiving section adapted to transmit and receive the base pulse;
a second transmitting/receiving section adapted to transmit and receive the data modulated pulse; and
a switch circuit adapted to connect either one of the transmitting circuit and the receiving circuit to the first and the second transmitting/receiving sections by switching.

7. A pulse communication method comprising:
a transmission step including
a base pulse generating step of generating a base pulse based on a base clock, and
n (n is an integer equal to or greater than 1) data modulated pulse generating steps of modulating a phase of the base pulse, which is generated based on the base clock, based on data to be transmitted and outputting the result as a data modulated pulse; and
a reception step including
n multiplication steps of multiplying a pair of pulses among the n data modulated pulses generated in the transmission step and the base pulse and outputting a multiplication signal, and
n restoring steps of restoring the data from the multiplication signals.
